(19) United States
(12) Patent Application Publication
(10) Pub. No.: US 2011/0117776 A1
(43) Pub. Date: May 19, 2011

(54) Integrally Conductive And Shielded Coaxial Cable Connector

(76) Inventors: Donald Andrew Burris, Peoria, AZ (US); William Bernard Lutz, Glendale, AZ (US)

(21) Appl. No.: 12/787,021

(22) Filed: May 25, 2010

Related U.S. Application Data
(60) Provisional application No. 61/261,541, filed on Nov. 16, 2009.

(51) Int. Cl. H01R 9/05

(52) U.S. Cl. 439/578

(57) ABSTRACT

The coaxial cable connector has a coupler, a post, and a ring that prevent interfaces from gapping and provide a robust alternative ground path that also RF shields the connector from both ingress and egress. The ring is disposed in between and engages at least a portion of a groove in the body and at least a portion of the channel in the coupler, radial movement of the coupler causes the axial movement of the body relative to the terminal.

### CROSS-REFERENCE TO RELATED APPLICATIONS

This application claims the benefit of, and priority to U.S. Provisional Patent Application No. 61/261,541 filed on Nov. 16, 2009 entitled, “Integrally Conductive and Shielded Coaxial Cable Connector”, the content of which is relied upon and incorporated herein by reference in its entirety.

### BACKGROUND OF THE INVENTION

1. Field of the Invention

The present invention relates generally to coaxial cable connectors, and particularly to coaxial cable connectors capable of securely connecting a coaxial cable to a terminal.

2. Technical Background

With the advent of digital signal in CATV systems, a rise in customer complaints due to poor picture quality in the form of signal interference resulting in what is known as “tiling” and the like has also occurred. Complaints of this nature result in CATV system operators having to send a technician to address the issue. Frequently it is reported by the technician that the cause of the problem is a loose F-connector fitting. Type F-connector fittings may be loose for many reasons; sometimes they are not properly tightened due to installation rules of system operators that prohibit the use of wrenches in-doors on customer equipment. Other times a homeowner may relocate equipment after the technician departs and may not adequately secure the F connectors. Additionally, some claim that F-connector couplers loosen due to vibration and/or heat and cold cycles.

Regardless, an improperly installed connector may result in poor signal transfer because there are discontinuities along the electrical path between the devices, resulting in a leak of radio frequency (“RF”) signal. That leak may be in the form of signal egress where the RF energy radiates out of the connector/cable arrangement. Alternately, an RF leak may be in the form of signal ingress where RF energy from an external source or sources may enter the connector/cable arrangement causing a signal to noise ratio problem resulting in an unacceptable picture.

Many of the current state of the art F connectors rely on intimate contact between the F male connector interface and the F female connector interface. If for some reason, the connector interfaces are allowed to pull apart from each other, such as in the case of a loose F male coupler, an interface “gap” may result. This gap can be a point of an RF leak as previously described.

To overcome this issue a number of approaches have been introduced including U.S. Pat. Nos. 7,114,990 (Bence, et al.); 7,479,035 (Bence, et al.); 6,716,062 (Palinkas, et al.) and US Patent application 20080102696 (Montena). While these approaches have been successful in varying degrees, it is desirable to provide a functioning connector junction that will operate at various stages of engagement.

To address the issue of loosening Type F couplers a number of approaches have been introduced including a lock-washer design produced by Phoenix Communications Technologies International (PCT), known at the TRS connector. While this approach may be somewhat successful in varying degrees, it is desirable to provide a functioning connector junction that will provide an improved locking mechanism.

It would be desirable therefore to provide a coaxial cable connector that provides a connection without gapping, an alternative ground path, and a way to RF shield both ingress and egress.

### SUMMARY OF THE INVENTION

Disclosed herein is coaxial cable connector for coupling an end of a coaxial cable to a terminal, the coaxial cable connector including a body, the body comprising a rear end, a front end, an external surface, and an internal surface extending between the rear and front ends of the body, the external surface having a groove, a coupler disposed proximate the front end of the body, the coupler having a front end and a back end and an opening extending therebetween, the opening having an internal surface and a channel in the internal surface, the opening receiving at least a portion of the body, and a ring having a forward facing surface and a rearward facing surface, the ring disposed in and engaging at least a portion of the groove in the body and at least a portion of the channel in the coupler, wherein radial movement of the coupler causes the axial movement of the body relative to the terminal.

In some embodiments, the coaxial cable connector includes a threaded member disposed in the opening of the coupler, the threaded member axially movable relative to the coupler and elastically biased against the front end of the body, the threaded member having a threaded opening to engage a corresponding threaded portion of the terminal.

In other embodiments, the front end of the body has fingers biased radially inward to engage a portion of the terminal.

In some embodiments, the internal surface of the coupler has a threaded portion to engage a corresponding threaded portion on a terminal.

According to another aspect of the invention, a coaxial cable connector for coupling an end of a coaxial cable to a terminal is disclosed, the coaxial cable connector includes a body, the body comprising a rear end, a front end, and an external surface, the body having a plurality of fingers at the front end of the body and the external surface having a groove and a threaded portion, a coupler disposed proximate the front end of the body, the coupler having a front end and a back end and an opening extending therebetween, the opening having an internal surface and a threaded portion in the internal surface corresponding to the threaded portion of the body, the opening receiving at least a portion of the body, and an elastic ring disposed in the opening of the coupler and adjacent the front end of the body, the elastic ring sealing the front end of the coupler when attached to the terminal.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a cross-sectional view of one embodiment of a coaxial cable connector according to the present invention prior to engagement;

FIG. 2 is a cross-sectional view of the coaxial cable connector of FIG. 1 in partial engagement;

FIG. 3 is a cross-sectional view of the coaxial cable connector of FIG. 1 in full engagement;

FIG. 4 is a cross-sectional view of an alternative embodiment of the coaxial cable connector of FIG. 1;

FIG. 5 is a cross-sectional view of an alternative embodiment of the coaxial cable connector of FIG. 1;

FIG. 6 is a cross-sectional view of an alternative embodiment of the coaxial cable connector of FIG. 1;

FIG. 7 is a cross-sectional view of an alternative embodiment of the coaxial cable connector of FIG. 1;

FIG. 8 is a cross-sectional view of an alternative embodiment of the coaxial cable connector of FIG. 1;

FIG. 9 is a cross-sectional view of another embodiment of a coaxial cable connector according to the present invention prior to engagement;

FIG. 10 is a cross-sectional view of the coaxial cable connector of FIG. 9 in partial engagement;

FIG. 11 is a cross-sectional view of the coaxial cable connector of FIG. 9 in full engagement;

FIG. 12 is a cross-sectional view of an alternative embodiment of the coaxial cable connector of FIG. 9;

FIG. 13 is a cross-sectional view of an alternative embodiment of the coaxial cable connector of FIG. 9;

FIG. 14 is a cross-sectional view of an alternative embodiment of the coaxial cable connector of FIG. 9;

FIG. 15 is a cross-sectional view of another embodiment of a coaxial cable connector according to the present invention prior to engagement;

FIG. 16 is a cross-sectional view of the coaxial cable connector of FIG. 15 in partial engagement;

FIG. 17 is a cross-sectional view of the coaxial cable connector of FIG. 15 in full engagement;

FIG. 18 is a partial cross-sectional view of an alternative embodiment of the coaxial cable connector of FIG. 15;

FIG. 19 is a cross-sectional view of an alternative embodiment of the coaxial cable connector of FIG. 15;

FIG. 20 is a cross-sectional view of an alternative embodiment of the coaxial cable connector of FIG. 15; and

FIG. 21 is a cross-sectional view of an alternative embodiment of the coaxial cable connector of FIG. 15.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

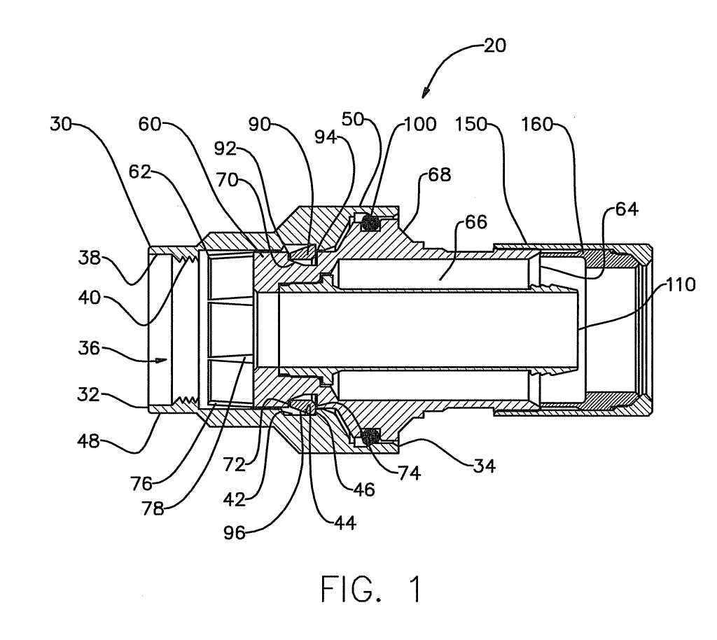

Referring to FIG. 1, a coaxial cable connector 20 has a coupler 30, a body 60, a ring 90, a sealing member 100, a post 110, a gripping member 160, and compression ring 150. The coaxial cable connector 20 is an axial-compression type coaxial cable connector and the connection of the coaxial cable connector 20 to a coaxial cable is known in the art. The coaxial cable connector 20 is illustrated in FIG. 1 in its unattached, uncompressed state. As described in more detail below, the ring 90 is snap fit onto the body 60. The coupler 30 is then disposed over the body 60 and the ring 90. The post 110 is then press-fit into the body 60. Finally, the gripping member 160, with the compression ring 150 disposed therein, is press-fit on to the body 60 to complete the coaxial cable connector 20. The coupler 30 is free to rotate around the post 110 in the front portion of the body 60.

The coupler 30 has a front end 32, a back end 34, and an opening 36 extending there between. The opening 36 of the coupler 30 has an internal surface 38. The internal surface 38 includes a threaded portion 40 and a channel 42. The channel 42 has a bottom surface 44 and a forward facing rear surface 46. The coupler 30 also has a smooth outer surface 48 adjacent the front end 32 and a hexagonal configuration 50 adjacent the back end 34. The coupler 30 is preferably made from a metallic material, such as brass, and it is plated with a conductive, corrosion-resistant material, such as nickel.

The body 60 includes a front end 62, rear end 64, and an opening 66 extending therebetween. The body 60 also has an outer surface 68, the outer surface 68 having a groove 70 near the front end 62. The groove 70 includes a rearward facing surface 72 and a forward facing surface 74. The body 60, and in particular the front end 62, has a plurality of fingers 76. The plurality of fingers 76 have an opening or slot 78 between each of the fingers 76. The plurality of fingers 76 are biased radially inward to engage a terminal, as described in detail below. The body 60 is also made from a metallic material, such as brass, and it is also plated with a conductive, corrosion-resistant material, such as tin.

Ring 90 is preferably a c-shaped tapered cone and is disposed within both the channel 42 and the groove 70. Ring 90 has a front end 92, a back end 94, and an external taper 96 such that ring 90 increases in outside diameter between the front end 92 and the back end 94. Ring 90 engages the channel 42 at the forward facing rear surface 46 and the rearward facing surface 72 of groove 70. Ring 90 is preferably made from a metallic material, such as heat treated beryllium copper.

A sealing member 100 can be included between the coupler 30 and the body 60 to prevent the ingress of moisture and debris, allowing the coaxial cable connector 20 to be used in an outdoor environment.

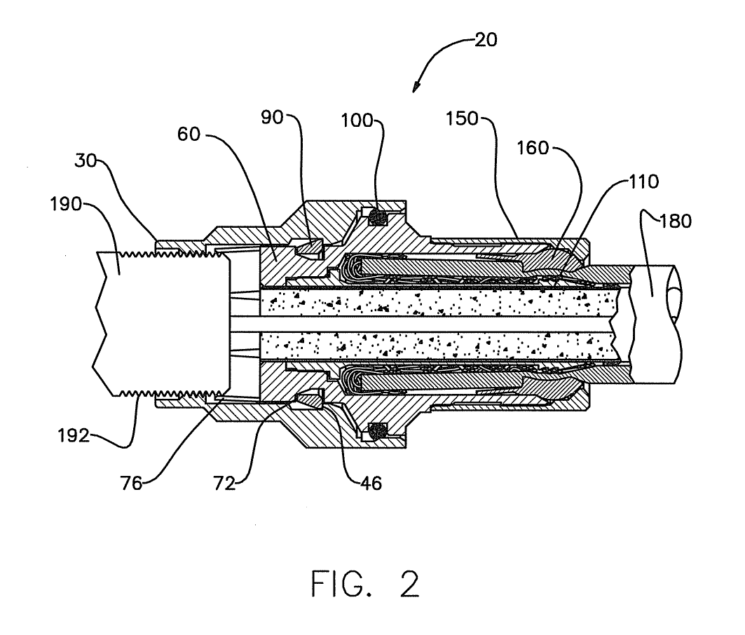

Turning to FIG. 2, the coaxial cable connector 20 has been installed onto a coaxial cable 180 as is known in the art. The coupler 30 of the coaxial cable connector 20 has been turned a few turns to engage a terminal 190 and, in particular, the threads 192 of the terminal 190. The fingers 76 have begun to engage the terminal 190 providing mechanical and electrical communication between the terminal 190 and coaxial cable connector 20, ensuring acceptable levels of RF performance in terms of grounding, shielding, and picture quality. As the coupler 30 of the coaxial cable connector 20 rotates and is drawn onto the terminal 190, the forward facing rear surface 46 of channel 42 engages the ring 90, which in turn engages the rearward facing surface 72 of groove 70, driving the body 60 forward so fingers 76 engage the terminal 190.

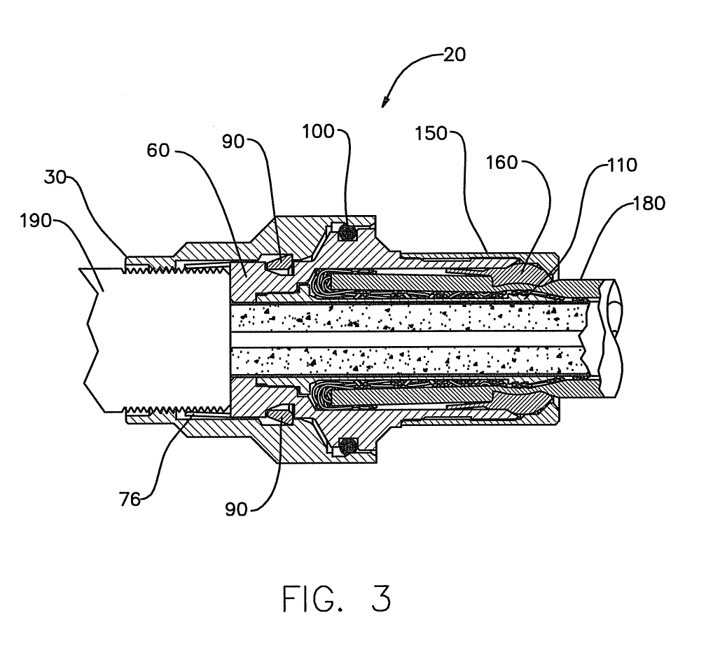

FIG. 3 illustrates the coaxial cable connector 20 fully engaged on the terminal 190, where the terminal 190 makes physical and electrical contact with the body 60 and the cable 180. The coupler 30 has been advanced as far as it can be on terminal 190. Since the body 60 is in contact with the terminal 190, the coupler 30 can not be turned any further due to the ring 90 engaging both the body 60 and the coupler 30.

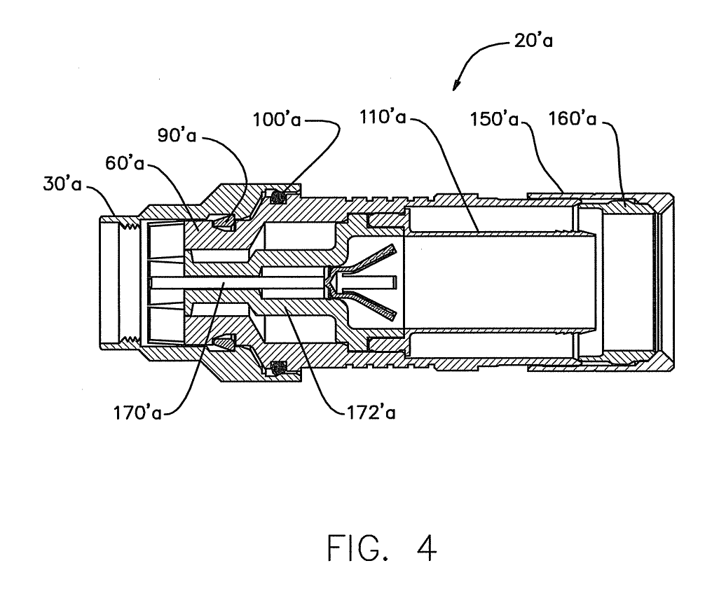

FIG. 4 illustrates an alternative embodiment of a coaxial cable connector 20′a. Coaxial cable connector 20′a includes a coupler 30′a, a body 60′a, a ring 90′a, a sealing member 100′a, a post 110′a, a gripping member 160′a, and compression ring 150′a. Coaxial cable connector 20′a also includes a pin 170′a that is disposed within a dielectric member 172′a. Although the body 60′a and the post 110′a have a slightly different configuration from coaxial cable connector 20′a, the function of these elements remains the same. As the coupler 30′a is rotated, the body 60′a is moved axially to engage a terminal (not shown) as discussed above. The remaining elements of coaxial cable connector 20′a also function as discussed and described above.

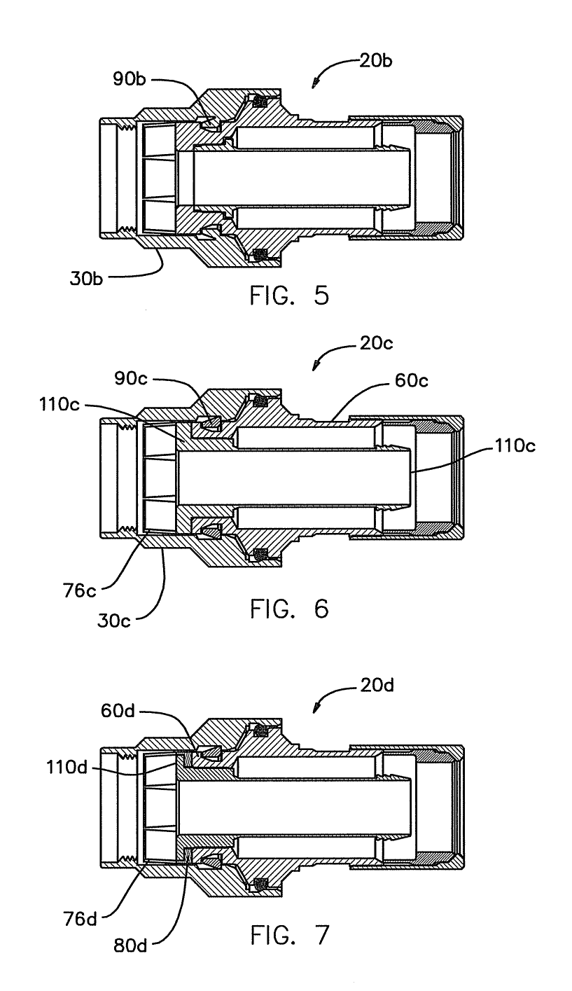

In FIG. 5, another alternative embodiment of a coaxial cable connector 20b is illustrated. Coaxial cable connector 20b has a coupler 30b that is preferably made from a plastic material with an integral ring 90b, rather than having it as an independent part of the coaxial cable connector 20b. The integral ring 90b would be molded at the same time as the coupler 30b.

Another alternative embodiment of a coaxial cable connector 20c is illustrated in FIG. 6. The coaxial cable connector 20c has the plurality of fingers 76c attached to a slightly modified post 110c rather than being attached to the body 60c. The post 110c, having the plurality of fingers 76c, is press fit into the body 60c from the front of the body 60c. The coupler 30c, as it is rotated to engage the terminal (not shown), engages the ring 90c, which in turn pushes the body 60c and the post 110c.

Yet another alternative embodiment of a coaxial cable connector 20d is illustrated in FIG. 7. In this embodiment of coaxial cable connector 20d, the plurality of fingers 76d are attached to a separate element 80d that is compressed between the body 60d and the post 110d. The coupler 30d, as it is rotated to engage the terminal (not shown), engages the ring 90d, which in turn pushes the post 110d, the element 80d with the plurality of fingers 76d, and the body 60d.

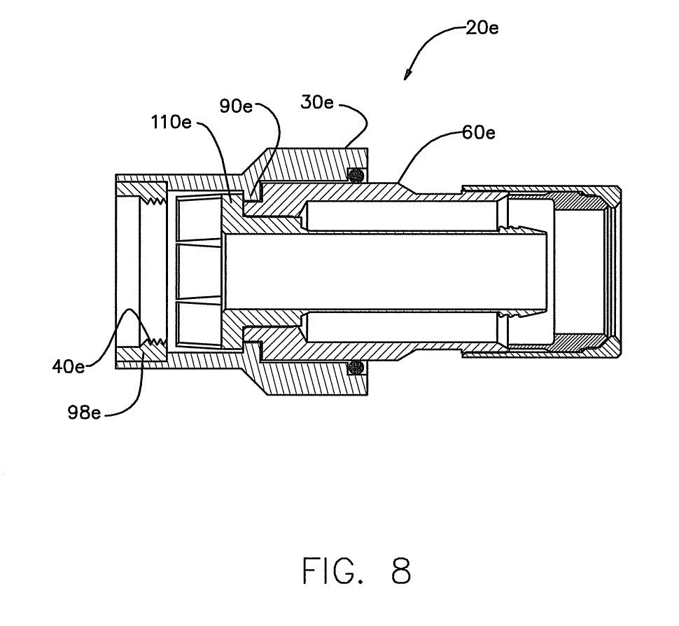

Another alternative embodiment of a coaxial cable connector 20e is illustrated in FIG. 8. In this embodiment of coaxial cable connector 20e, the coupler 30e has a projection 90e that functions as the ring from the other embodiments. The projection 90e engages the post 110e and pulls the terminal in to the coaxial cable connector 20e as the coupler 30e is rotated. It should be noted that with this configuration, the coupler 30e is placed on the body 60e and the post 110e is then press-fit into the body 60e, capturing the coupler 30e therebetween. To allow for this assembly, the threads 40e are formed into an insert 98e, which is press-fit into the front portion of the coupler 30e after the coupler 30e, the post 110e and the body 60e are assembled.

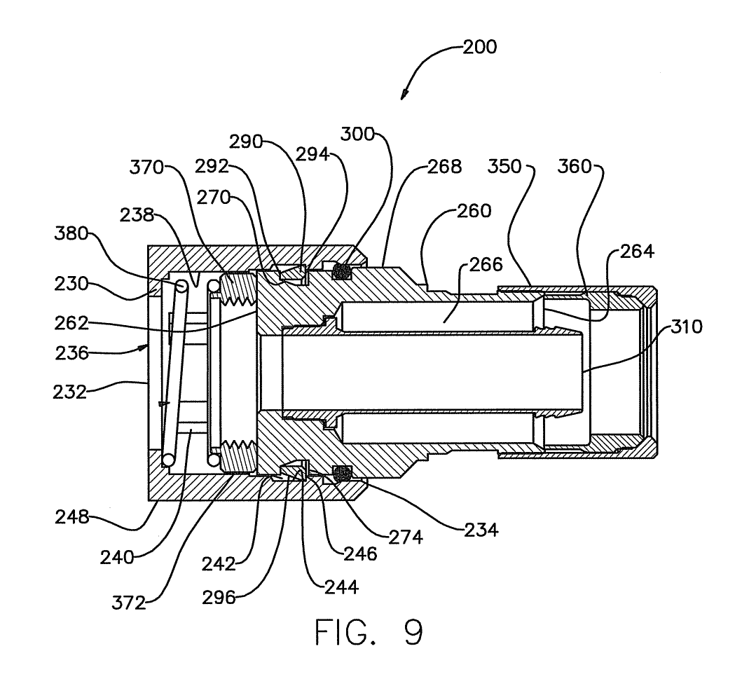

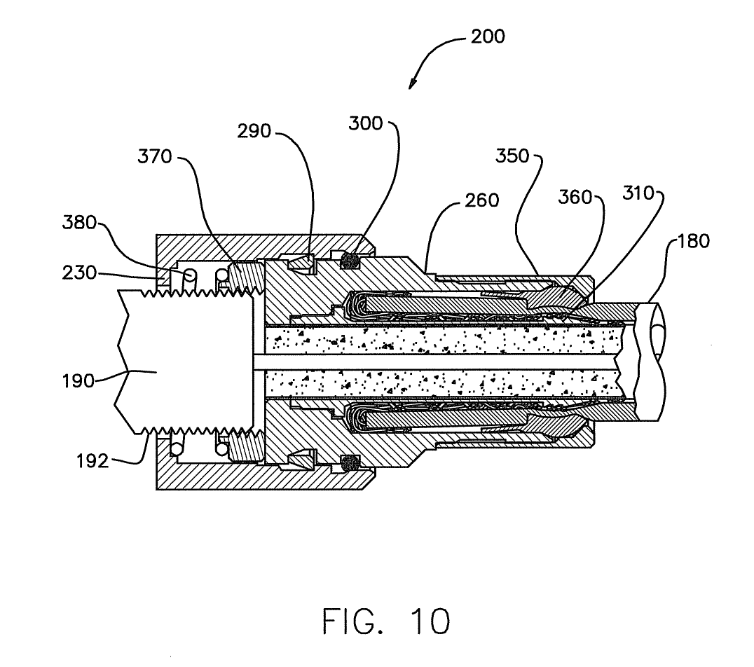

Another embodiment of a coaxial cable connector 200 according to the present invention is illustrated in FIG. 9. The coaxial cable connector 200 has a coupler 230, a body 260, a ring 290, a sealing member 300, a post 310, a gripping member 360, and compression ring 350. Coaxial cable connector 200 also has a threaded member 370 and a helical spring 380 disposed in the coupler 230. The coaxial cable connector 200 is an axial-compression type coaxial cable connector and the connection of the coaxial cable connector 200 to a coaxial cable is known in the art. The coaxial cable connector 200, as illustrated in FIG. 9, is in its unattached, uncompressed state.

The coupler 230 has a front end 232, a back end 234, and an opening 236 extending there between. The opening 236 of the coupler 230 has an internal surface 238. The internal surface 238 includes a hexagonal portion 240 and a channel 242. The channel 242 has a bottom surface 244 and a forward facing rear surface 246. The coupler 230 may have either a smooth outer surface 248 or hexagonal configuration. The coupler 230 is preferably made from a metallic material, such as brass, and it is plated with a conductive, corrosion-resistant material, such as nickel. The coupler 230 may alternatively be made of a plastic material.

The body 260 includes a front end 262, rear end 264, and an opening 266 extending therebetween. The body 260 also includes an outer surface 268, the outer surface 268 having a groove 270 near the front end 262. The groove 270 also includes a rearward facing surface 272 and a forward facing surface 274. The body 260 is also made from a metallic material, such as brass, and it is also plated with a conductive, corrosion-resistant material, such as tin.

Ring 290 is preferably a c-shaped tapered cone and is disposed within both the channel 242 and the groove 270. Ring 290 has a front end 292, a back end 294, and an external taper 296 such that ring 290 increases in outside diameter between the front end 292 and the back end 294. Ring 290 engages the channel 242 at the forward facing rear surface 246 and the rearward facing surface 272 of groove 270. Ring 290 is preferably made from a metallic material, such as heat treated beryllium copper.

A sealing member 300 can be included between the coupler 230 and the body 260 to prevent the ingress of moisture and debris, allowing the coaxial cable connector 200 to be used in an outdoor environment.

Threaded member 370 has an external hexagonal configuration 372 that has a sliding clearance fit with the hexagonal portion 240 of coupler 230. The sliding clearance fit of threaded member 370 permits nesting of threaded member 370 within the hexagonal portion 240 of coupler 230 while allowing axial movement of threaded member 370 within coupler 230. Further, this nesting relationship permits internal threaded member 370 to be rotatably moved by the rotation of coupler 230.

Helical spring 380 is housed within coupler 230 between the front end 232 and the threaded member 370. The helical spring 380 biases the threaded member 370 into intimate contact with body 260. Helical spring 380 is preferably made from a heat treated spring steel and is preferably in a coil type arrangement as illustrated, but may alternately be constructed of a plastic material. As a further alternate configuration, helical spring 380 may be formed in stamped, flattened shape such as a wave washer or conical configuration.

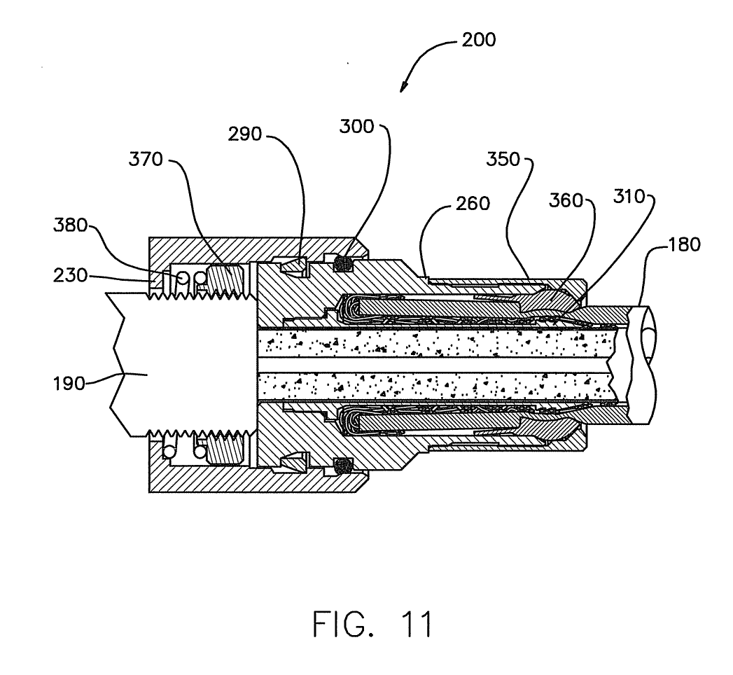

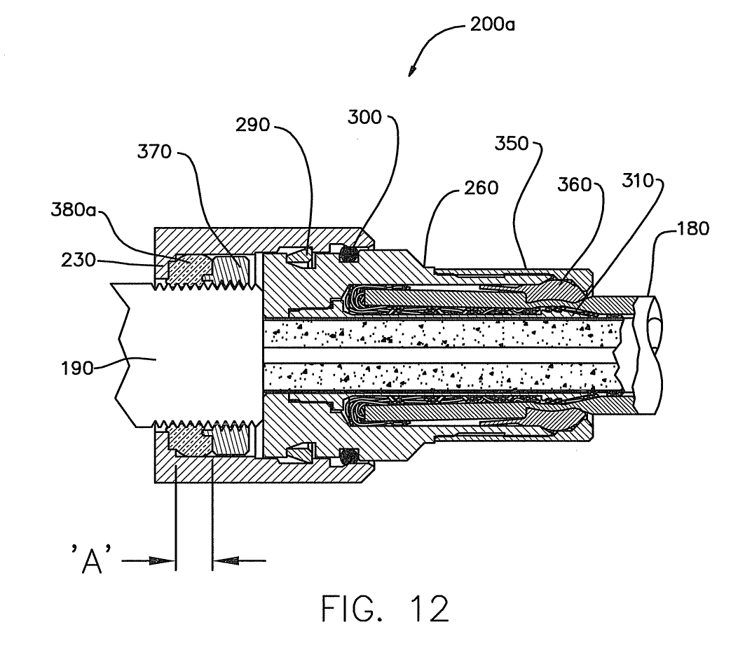

As illustrated in FIG. 10, the terminal 190 has been inserted through the opening 236 at the front end 232 of a coupler 230 where the threaded member 370 has been rotated by the rotation of coupler 230 and has engaged the terminal 190 and, more specifically, the threads 192. A coaxial cable 180 has been installed on the coaxial cable connector 200. The helical spring 380 biases the threaded member 370 against the body 260. As the coupler 230 is rotated (and rotating the threaded member 370), the terminal 190 engages even more of the body 260. See FIG. 11. As the coupler 230 is further rotated, the threaded member 370 moves along the terminal 190 towards the front end 232 of the coupler 230. The relative positions of the coupler 230 and the body 260 remain the same during rotation of the coupler 230 because of the ring 290. Ring 290 allows the coupler 230 to rotate about the body 260, but rather than the body 260 moving axially to engage the terminal 190, the threaded member 370 moves. With helical spring 380 positioned between the threaded member 270 and the front end 232 of the coupler, an increasing force on the threaded member 370, due to compression of the spring 380, keeps the terminal 190 in contact with the body 260.

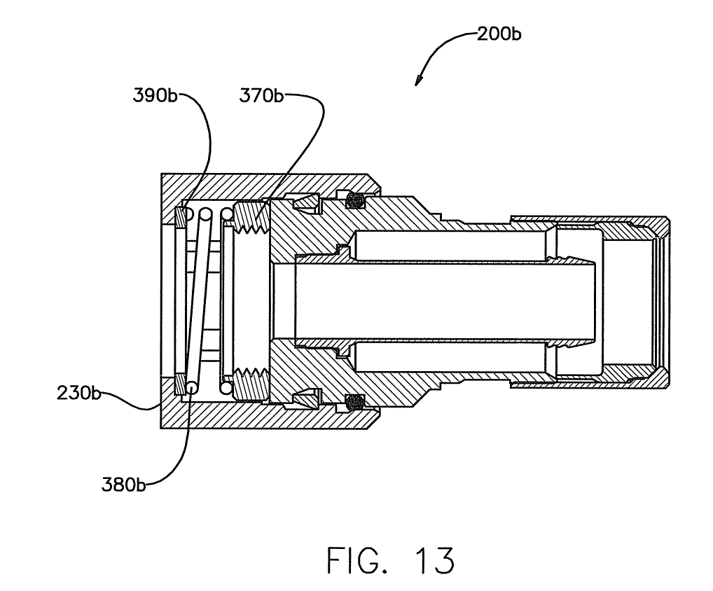

As a further alternate configuration, helical spring 380 may be constructed from a rubber material or conductive rubber material thus providing a combination of spring force, environmental sealing characteristics, RF sealing characteristics, and/or electrical grounding functions as illustrated as ring spring 380a in FIG. 12. The ring spring 380a is constructed from a rubber material or a conductive rubber and is illustrated in FIG. 12 and a compressed or activated condition. As the coupler 230 is rotated and the threaded member 370 is advanced along the terminal 190, the gap “A” is reduced and the ring spring 380a provides a number of advantages. First, the ring spring 380a fills the space between the threaded member 370, the front end 232 of the coupler 230, and the terminal 190. The ring spring 380a also provides environmental sealing of the coaxial cable connector 200a, RF sealing characteristics, electrical grounding functions, and an increased resistance to axial movement of the coupler 230 and the threaded member 370.

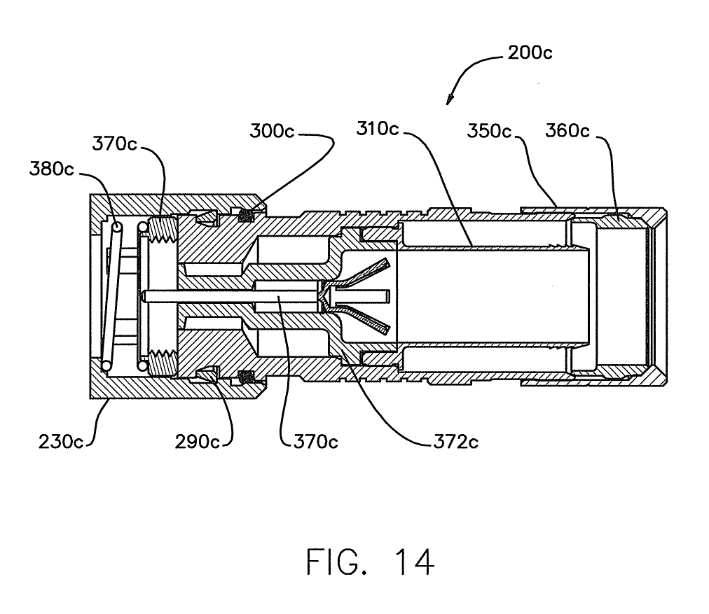

FIG. 13 illustrates an alternative embodiment of a coaxial cable connector 200b. In coaxial cable connector 200b, a washer 390b is disposed between the front of the coupler 230b and the helical spring 380b, which is biased against the threaded member 370b.

FIG. 14 illustrates an alternative embodiment of a coaxial cable connector 200c. Coaxial cable connector 200c includes a coupler 230c, a body 260c, a ring 290c, a sealing member 300c, a post 310c, a gripping member 360c, compression ring 350c, and a threaded member 370c and a helical spring 380c disposed in the coupler 230c. Coaxial cable connector 200c also includes a pin 370c that is disposed within a dielectric member 372c, both of which are disposed within the body 260c. Although the body 260c and the post 310c have a slightly different configuration from coaxial cable connector 200, the function of these elements remains the same. As the coupler 230c is rotated, the body 260c maintains contact with the terminal (not shown) as discussed above. The remaining elements of coaxial cable connector 200c also function as discussed and described above.

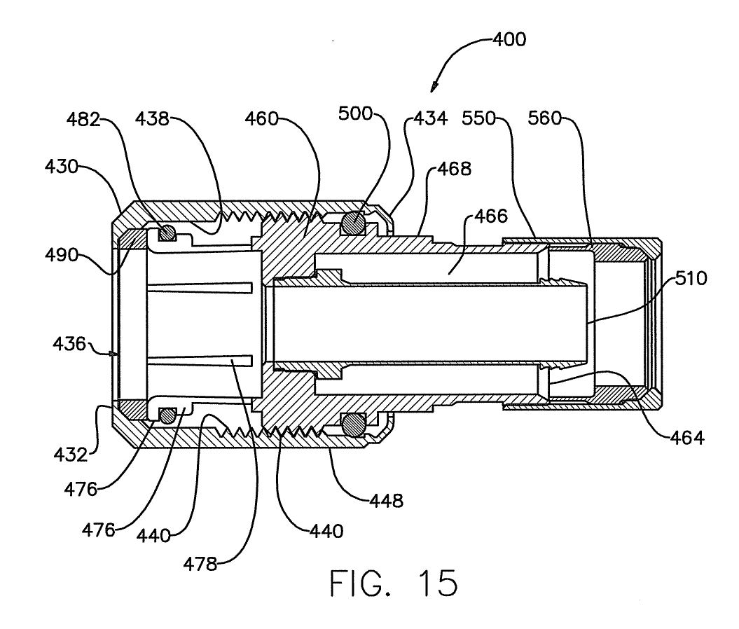

Another embodiment of the coaxial cable connector 400 according to the present invention is illustrated in FIG. 15. The coaxial cable connector 400 has a coupler 430, a body 460, a ring 490, a sealing member 500, a post 510, a gripping member 560, and a compression ring 550. This connector is also an axial-compression type coaxial cable connector and the connection of the coaxial cable connector 400 to a coaxial cable is known in the art.

The coupler 430 has a front end 432, a back end 434, and an opening 436 extending therebetween. The opening 436 of the coupler 430 has an internal surface 438. The internal surface 438 includes a threaded portion 440. Threaded portion 440 and the corresponding threads on the body 460 are preferably left-handed. The back end 434 is preferably rolled-over toward the body 460 to prevent the coupler 430 from being rotated off the front of the coaxial cable connector 400. The coupler 430 may have either a smooth outer surface 448 or hexagonal configuration. The coupler 430 is preferably made from a metallic material, such as brass, and it is plated with a conductive, corrosion-resistant material, such as nickel. The coupler 430 may alternatively be made of a plastic material.

The body 460 includes a front end 462, rear end 464, and an opening 466 extending therebetween. The body 460 also includes an outer surface 468. The body 460 has at its front end 462 a plurality of fingers 476, between each of the fingers 476 is an opening or slot 478. The front end 462 and the plurality of fingers 476 are encircled by a circlip or a snap ring 482. The snap ring 482 may be constructed from a metallic material such as heat-treated spring steel or, alternatively, from a rubber material or conductive rubber material, thus providing a combination environmental sealing characteristics, RF sealing characteristics, and/or electrical grounding functions. The body 460 is also made from a metallic material, such as brass, and it is also plated with a conductive, corrosion-resistant material, such as tin.

A sealing member 500 can be included between the coupler 430 and the body 460 to prevent the ingress of moisture and debris, allowing the coaxial cable connector 400 to be used in an outdoor environment.

The ring 490 is disposed between the front end of 462 of the body 460 and the front end 432 of the coupler 430. Ring 490 is constructed from a rubber material or a conductive rubber and is illustrated in FIG. 15 in an uncompressed or un-activated condition.

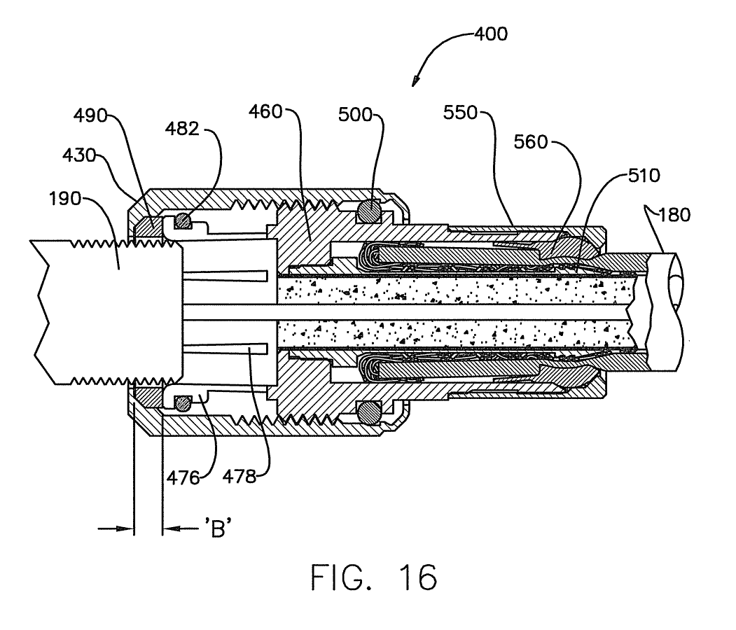

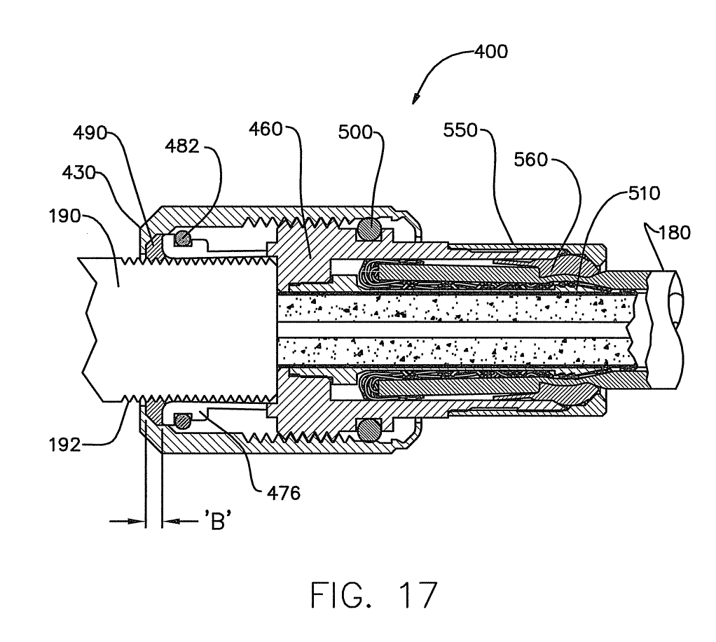

As illustrated in FIG. 16, the terminal 190 has been inserted through the opening 436 at the front end 432 of a coupler 430 where the fingers 476 have engaged the terminal 190, and more specifically, the threads 192. A coaxial cable 180 has been installed on the coaxial cable connector 400. The circlip or a snap ring 482 biases the fingers 476 against the terminal 190. The ring 490 fills the gap “B” as illustrated in FIG. 16. However, after the terminal 190 is inserted into the coupler 430 and as the coupler 430 is rotated (using the left-handed threads), the gap “B” is reduced as the ring 490 fills the space between the front end 432 of the coupler 430, the front end 462 of the body 460, and the terminal 190. See FIG. 17. The ring 490 may also provide environmental sealing of the coaxial cable connector 400, RF sealing characteristics, electrical grounding functions, and an increased resistance to axial movement of the coupler 430.

As the coupler 430 is further rotated as illustrated in FIG. 17, the front end 432 of the coupler 430 moves backward relative to the front end 462 of the body 460 and the terminal 190. This causes the front end 462 of the body 460, and in particular the fingers 476, engage the front end 432 of the coupler 430 forcing the fingers 476 radially inward to apply even more pressure on the terminal 190.

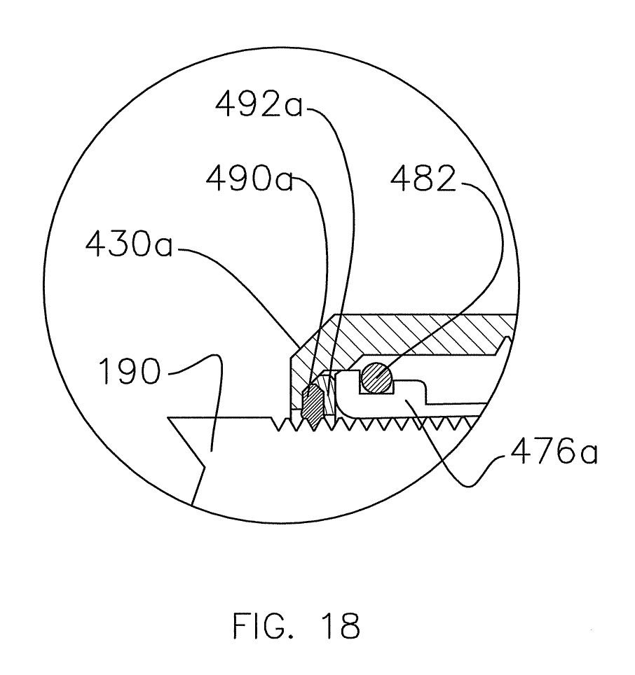

An alternative embodiment of coaxial cable connector 400a is partially illustrated in FIG. 18. The coaxial cable connector 400a has a coupler 430a and fingers 476a that engage the terminal 190. A ring 490a is also disposed between the coupler 430a and the fingers 476a. However, a backing ring 492a is positioned between the ring 490a and the fingers 476a, and assists in keeping the ring 490a from entering the opening or slots 478 between the fingers 476a. The backing ring 492a is preferably made of metal, such as brass, and plated with a conductive, corrosion-resistant material, such as nickel.

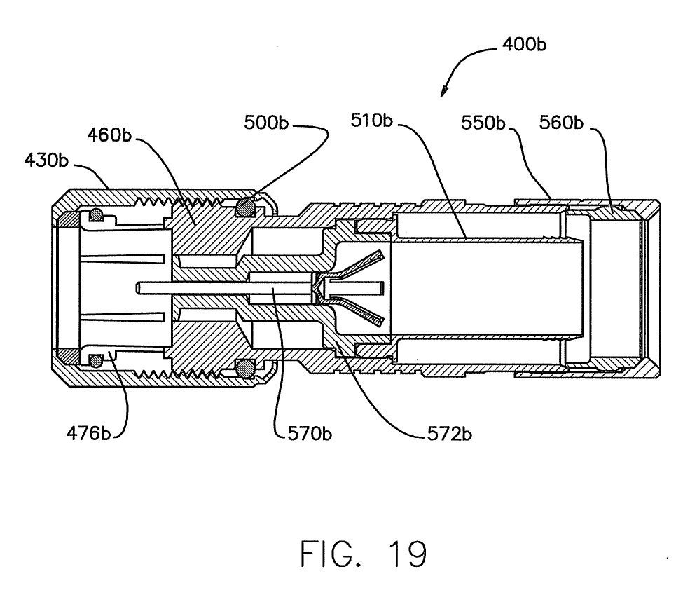

FIG. 19 illustrates yet another alternative embodiment of a coaxial cable connector 400b. The coaxial cable connector 400b has a coupler 430b, a body 460b, a sealing member 500b, a post 510b, a gripping member 560b, and a compression ring 550b. Coaxial cable connector 400b also includes a pin 570b that is disposed within a dielectric member 572b, both of which are disposed within the body 460b. Although the body 460b and the post 410b have a slightly different configuration from coaxial cable connector 400, the function of these elements remains the same. As the coupler 430b is rotated, the plurality of fingers 476b maintain contact with the terminal (not shown) as discussed above. The remaining elements of coaxial cable connector 400b also function as discussed and described above.

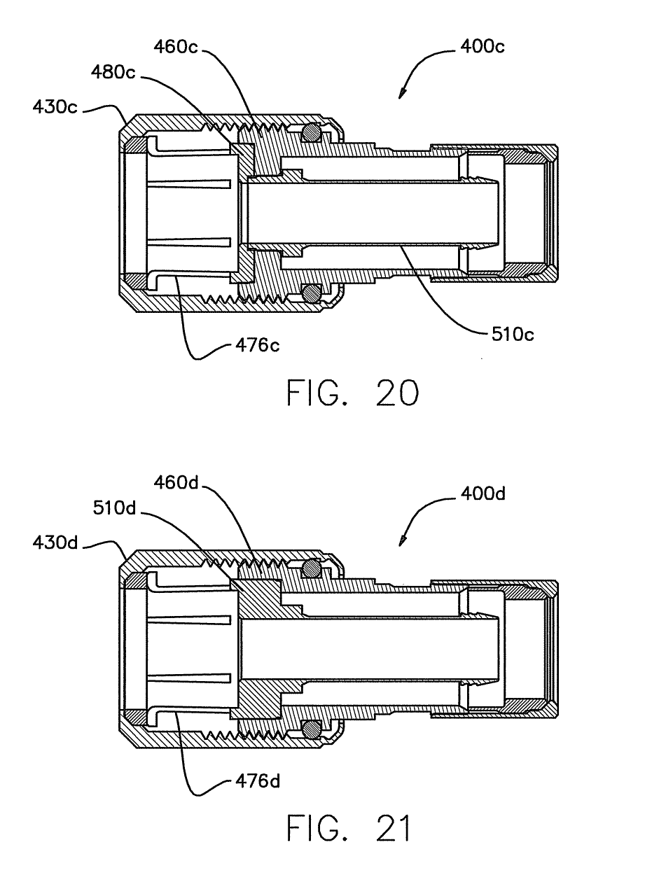

Another alternative embodiment of a coaxial cable connector 400c is illustrated in FIG. 20. In coaxial cable connector 400c, the plurality of fingers 476c are attached to a separate element 480c, which is then press fit into the front of the body 460c. The post 510c may also partially engage the separate element 480c, having also been press fit into the body 460c. As the coupler 430c is rotated, it engages the body 460c, which moves the separate element 480c (and also the post 510c) forward so the plurality of fingers 476c engage the front of the coupler 430c in the same manner as discussed above. The plurality of fingers 476c are preferably made with heat-treated beryllium copper, which makes the plurality of fingers 476c more elastic and eliminates the need for the circlip or snap ring of the prior embodiments.

Yet another alternative embodiment of a coaxial cable connector 400d is illustrated in FIG. 21. In coaxial cable connector 400d, the plurality of fingers 476d are attached to the post 510d, which is press fit into the body 460d. The coupler 430d, as it is rotated to engage the terminal (not shown), moves the body 460d forward, which also moves the post 510d forward so the plurality of fingers 476d engage the front of the coupler 430d as in the other embodiments. The plurality of fingers 476d are preferably made with heat-treated beryllium copper, which makes the plurality of fingers 476d more elastic and eliminates the need for the circlip or snap ring.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A coaxial cable connector for coupling an end of a coaxial cable to a terminal, the coaxial cable connector comprising:
a body, the body comprising a rear end, a front end, an external surface, and an internal surface extending between the rear and front ends of the body, the external surface having a groove;
a coupler disposed proximate the front end of the body, the coupler having a front end and a back end and an opening extending therebetween, the opening having an internal surface and a channel in the internal surface, the opening receiving at least a portion of the body; and
a ring having a forward facing surface and a rearward facing surface, the ring disposed in and engaging at least a portion of the groove in the body and at least a portion of the channel in the coupler, wherein radial movement of the coupler causes the axial movement of the body relative to the terminal.

2. The coaxial cable connector according to claim 1, further comprising a threaded member disposed in the opening of the coupler, the threaded member axially movable relative to the coupler and elastically biased against the front end of the body, the threaded member having a threaded opening to engage a corresponding threaded portion of the terminal.

3. The coaxial cable connector according to claim 2, further comprising a helical spring disposed between the threaded member and the front end of the body to elastically bias the threaded member toward the body.

4. The coaxial cable connector according to claim 2, further comprising an elastic ring disposed between the threaded member and the front end of the body to elastically bias the threaded member toward the body.

5. The coaxial cable connector according to claim 1, further comprising a sealing member disposed between the coupler and the body.

6. The coaxial cable connector according to claim 2, wherein the internal surface of coupler engages at least a portion of an outer surface of the threaded member, wherein rotation of the coupler about the body causes rotation of the threaded member.

7. The coaxial cable connector according to claim 1, the front end of the body having fingers biased radially inward to engage a portion of the terminal.

8. The coaxial cable connector according to claim 1, the internal surface of the coupler having a threaded portion to engage a corresponding threaded portion on a terminal.

9. The coaxial cable connector according to claim 8, wherein rotation of the coupler when engaging a terminal draws the terminal into physical and electrical contact with the body.

10. A coaxial cable connector for coupling an end of a coaxial cable to a terminal, the coaxial cable connector comprising:
a body, the body comprising a rear end, a front end, and an external surface, the body having a plurality of fingers at the front end of the body and the external surface having a groove and a threaded portion;
a coupler disposed proximate the front end of the body, the coupler having a front end and a back end and an opening extending therebetween, the opening having an internal surface and a threaded portion in the internal surface corresponding to the threaded portion of the body, the opening receiving at least a portion of the body; and
an elastic ring disposed in the opening of the coupler and adjacent the front end of the body, the elastic ring sealing the front end of the coupler when attached to the terminal.

11. The coaxial cable connector according to claim 10, further comprising a circular member disposed around at least a portion of the plurality of fingers.

12. The coaxial cable connector according to claim 10, wherein the threaded portions are left-handed threads.

13. The coaxial cable connector according to claim 10, wherein rotation of the coupler moves the body axially forward relative to the coupler, the fingers of the body compressing the elastic ring against the internal surface of the coupler at the front end to seal the opening.

14. The coaxial cable connector according to claim 13, wherein the plurality of fingers engages the internal surface of the coupler at the front end thereof.
